(19) United States
(12) Patent Application Publication
(10) Pub. No.: US 2017/0201054 A1
(43) Pub. Date: Jul. 13, 2017

(54) ADAPTER FOR MOUNTING SINGLE- OR MULTI-PIN OVERVOLTAGE PROTECTION DEVICES THAT ARE DESIGNED AS PLUG-IN MODULES, AND USE OF SUCH AN ADAPTER

(71) Applicant: DEHN + SÖHNE GMBH + CO. KG, Neumarkt/Opf. (DE)

(72) Inventors: Georg WITTMANN, Lauterhofen (DE); Edmund ZAUNER, Berching/Pollanten (DE); Thomas GOTTSCHALK, Wappersdorf (DE); Manuel SCHARF, Ursensollen (DE)

(21) Appl. No.: 15/312,811

(22) PCT Filed: May 21, 2015
(86) PCT No.: PCT/EP2015/061271

§ 371 Date: Nov. 21, 2016

(30) Foreign Application Priority Data
May 26, 2014 (DE) 20 2014 004 396.5
Sep. 4, 2014 (DE) 10 2014 112 722.6

(51) Int. Cl. H01R 33/94; H01R 13/631; H01R 13/66; H01R 12/71; H01R 13/44; H01R 12/70; H01R 13/04

(52) U.S. Cl. CPC H01R 33/94; H01R 12/7005; H01R 12/7082; H01R 13/631; H01R 13/04; H01R 12/716; H01R 13/44; H01R 13/6666

(57) ABSTRACT

The invention relates to an adapter for mounting single- or multi-pin overvoltage protection devices that are designed as plug-in modules on a wiring carrier, wherein the adapter has a base and at least one chamber that is open upward and bounded by side walls, from the bottom side of which chamber a plurality of mounting protrusions extend, which each have a contour that is substantially complementary to corresponding openings in the wiring carrier. According to the invention, the mounting protrusions have a hook shape in order to engage under the wiring carrier as a result of sliding of the adapter in the plane of the wiring carrier, after the adapter has been inserted into the openings by means of the mounting protrusions, wherein through-holes are formed in the base, the dimensions of which through-holes allow plug-in connections of the plug-in modules to be fed through to the wiring carrier. Furthermore, metallized holes corresponding to the dimensions of the plug-in connections of the plug-in module are formed in the wiring carrier in such a way that the holes are located congruently with the through-holes in the base after the adapter has been inserted and slid, such that self-securing locking of the combination of the adapter, the plug-in module, and the wiring carrier is provided in addition to electrical contacting, after the plug-in module has been inserted.

The invention relates to an adapter for mounting single-pin or multipin overvoltage protection devices that are designed as plug-in modules on a wiring carrier, wherein the adapter has a base and at least one chamber, which is open on top and is delimited by side walls, from the lower side of which multiple mounting extensions extend, which each have a contour, which is essentially complementary to corresponding openings in the wiring carrier, according to the preamble of claim 1. The invention furthermore relates to the use of such an adapter for solderless mounting and surge-current-resistant connection of plug-in modules on or to wiring carriers, in particular circuit boards, in turn in particular multilayer, through-contacted circuit boards here.

An adapter for button-shaped overvoltage arresters for use in sockets having springy contact elements is known from CH 439 462. The adapters therein are to be understood as sockets in which overvoltage arresters are to be inserted. Specifically, the previously known adapter has two U-shaped, equivalent rails, which face toward the electrically conductive socket parts, and between which the arrester is insertable by raising a leaf spring located between the rails. In addition, two equivalent housing halves consisting of insulating material are provided. The two halves can be joined together, offset by 180°, by pins and perforations on the respective housing half. Such an adapter can then be connected to a wiring carrier.

DE 41 11 025 A1 discloses a device for fastening series built-in devices in switchboards. In this case, the fastening is also to be implementable without known means for top-hat rail mounting. The device for this purpose consists of a base plate, two carrier elements, and a screen. The devices fitted into a front plate are locked with the carrier elements by means of a catch device. The two carrier elements are then fixable in a tilt-proof manner in the base plate in catch receptacles by means of terminally arranged support and catch devices. The device can be assembled without using screw elements or the like by way of the provided catch means.

Furthermore, an adapter having means for fastening on a support rail is known according to DE 202 16 516 U1. This adapter enables an adaptation of, for example, safeguards or circuit breakers for mounting on top-hat rails. Catch means provided therein interact with a slide, wherein a springy catch arm is described as a preferred embodiment.

DE 10 2009 004 346 B4, which forms the species, relates to an adapter for mounting single-pin or multipin overvoltage protection devices that are designed as producer-specific standard plug-in modules in terminals, comprising a base having means for electrical connection of the replaceable standard plug-in modules accommodated in the respective base to the terminal application circuit. The device according to DE 10 2009 004 346 B4 is to enable standard plug-in modules to be able to be used in various applications without any type of alterations or also without placing special demands on the construction or the design of the relevant terminal. In this regard, the adapter has a base having at least two chambers, which are open on top and are delimited by side walls, from the lower side of which at least one mounting and alignment extension extends. The corresponding mounting and alignment extension has a cross-sectional shape which is essentially complementary to an opening in the wiring carrier of the terminal.

In addition, terminal regions are led outside from the chamber region which can be occupied by the respective plug-in module, which connection regions enable a direct or indirect electrical connection to the wiring carrier of the terminal application circuit.

DE 10 2009 004 346 B4 thus provides a possibility for also using the cost-effective technology of series built-in devices for more specialized terminal applications.

However, it is fundamentally necessary according to DE 10 2009 004 346 B4 to lead terminal parts out in the region of the base, which establish a connection to the plug-in module, on the one hand, and ensure the corresponding electrical connection or the connection to the terminal application, on the other hand. In this case, the connection is executable via a solder tail, or also via screws or pins.

Overvoltage protection devices for device combinations are typically connected by a soldered connection to wiring carriers, in particular circuit boards. This is necessary to keep the contact resistance low in the event of high surge currents and prevent a destruction of the connections in the event of occurring electromechanical forces.

These known soldering processes for connecting the overvoltage protection devices to the carrier system have the disadvantage that the protective combination is already thermally strained during mounting. In addition, the manufacturing effort is high.

Although solderless plug-in or catch connections of circuit boards to cables or circuit boards having other electronic components are previously known, such connection technologies are problematic in the field of overvoltage protection, and this is not only because of the very low surge current carrying capacity.

From the above statements, it is therefore the object of the invention to specify a refined adapter for mounting single-pin or multipin overvoltage protection devices that are designed as plug-in modules on a wiring carrier, wherein a solderless mounting without electrical contacting is to be implementable with the aid of the adapter, and furthermore the provided mechanical and electrical connection is surge-current-resistant and therefore resists all forces occurring in the respective load case.

A further object of the invention is to design the adapter so that self-locking of the entire module made of wiring carrier, adapter, and plug-in module results and manipulations on this arrangement can be substantially precluded.

The object of the invention is achieved by an adapter for mounting single-pin or multipin overvoltage protection devices that are designed as plug-in modules on a wiring carrier according to the combination of features according to claim 1, wherein the dependent claims are at least advantageous embodiments and refinements.

The use of the provided adapter for the solderless mounting and surge-current-resistant connection of plug-in modules on or to wiring carriers, in particular circuit boards, is additionally according to the invention.

Accordingly, the invention proceeds from an adapter for mounting single-pin or multipin overvoltage protection devices that are designed as plug-in modules on a wiring carrier. The plug-in modules can be standard plug-in modules of the corresponding producer here, which are also insertable into routine base parts in this regard and are usable accordingly.

The adapter according to the invention has a base and at least one chamber, which is open on top and is delimited by side walls. The chamber is used to accommodate the respective plug-in module. Multiple mounting extensions extend from the lower side of the chamber, which mounting extensions each have a contour which is essentially complementary to corresponding openings in the wiring carrier. In this manner, the adapter can be plugged using its mounting extensions into the openings in the wiring carrier.

According to the invention, the mounting extensions have a hook shape or a hook-like shape, in order, after insertion of the adapter using its mounting extensions into the openings in the wiring carrier, to engage below them by displacement of the adapter in the plane of the wiring carrier and fix the adapter.

Furthermore, perforations are formed in the base according to the invention, the dimensions of which enable plug terminals of the plug-in module to be led through to the wiring carrier.

In addition, metallized recesses are formed in the wiring carrier corresponding to the dimensions of the plug terminals of the plug-in module, in such a manner that the recesses, after insertion of the adapter and the displacement thereof, are located congruently in relation to the perforations in the base. In this manner, after insertion of the plug-in module, self-securing locking of the composite made of adapter, plug-in module, and wiring carrier can be implemented, in addition to electrical contacting.

In a refinement of the invention, the plug terminals of the plug-in module are formed bent in a U shape, wherein a support element is located between the U legs. The support element can be a plastic extension formed onto the housing of the plug-in module and the support element is used to stabilize the U-shaped plug terminals during the pressing into the corresponding through contact recesses of the wiring carrier.

The cross section of the plug terminals preferably has a rectangular shape. The recesses in the wiring carrier have a complementary design. The gradation of the dimensions with respect to plug terminals and recesses in the wiring carrier is selected so that a friction lock having good electrical contacting is provided.

The recesses in the wiring carrier are preferably formed as electrical through contacts and are connected to corresponding conductor tracks of the terminal circuit.

Catch means known per se are provided between the side walls of the chamber and the plug-in module.

At least one wiring carrier fastening borehole is provided on the wiring carrier below the base, the axis of which is concealed by the adapter after its mounting on the wiring carrier. A removal of the wiring carrier by unscrewing is not made impossible by this measure, but is at least made more difficult.

The catch means in the side walls of the chamber comprise openings provided therein, in each of which a catch lug, which is located laterally on the plug-in module, engages. The respective catch lug is located at the end of a movable actuating surface and has an insertion bevel for easier sliding into the respective opening of the respective side wall.

The actuating surfaces correspond to those of typical plug-in modules, in which the replacement in case of fault is possible by actuation, i.e., pressure on the actuating surface. If such manipulations are to be precluded in this regard in the embodiment according to the invention, the solution according to the invention engages here, according to which the side walls are to predominantly or completely conceal the actuating surfaces in the plugged state and after completed locking of the plug-in module. It is therefore no longer possible to remove the plug-in module by pressure on the actuating surfaces.

Of course—if desired—the height of the side walls can also be limited, to ensure free accessibility to the actuating surfaces of the plug-in module.

A use according to the invention of the adapter consists of the solderless mounting and surge-current-resistant connection of plug-in modules on or to wiring carriers, in particular circuit boards here, and in turn in particular multilayer, through-contacted circuit boards.

The invention will be explained in greater detail on the basis of exemplary embodiments and with the aid of figures.

In the figures:

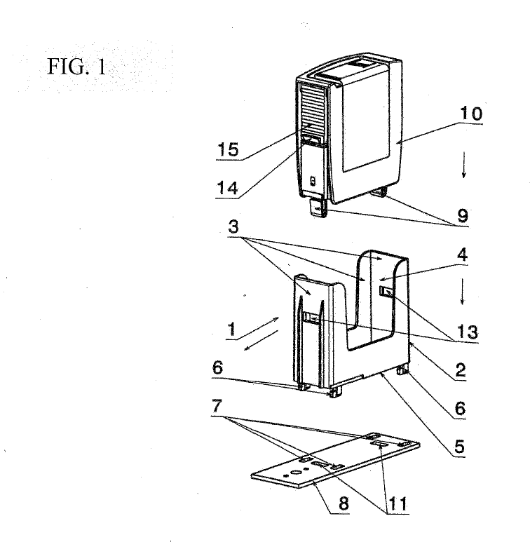

FIG. 1 shows a perspective illustration of the elements wiring carrier, adapter, and plug-in module before the mounting;

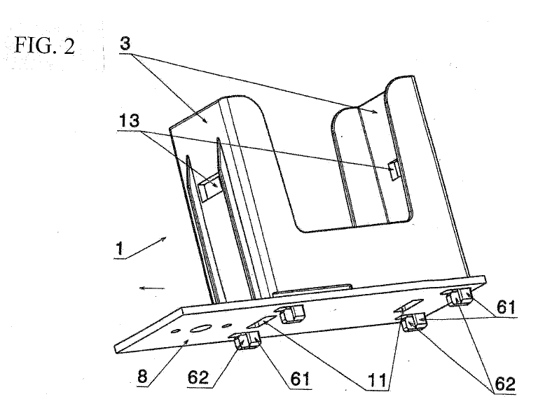

FIG. 2 shows a perspective illustration of adapter and wiring carrier including mounting extensions in the inserted state, which is not yet locked, however, between adapter and wiring carrier;

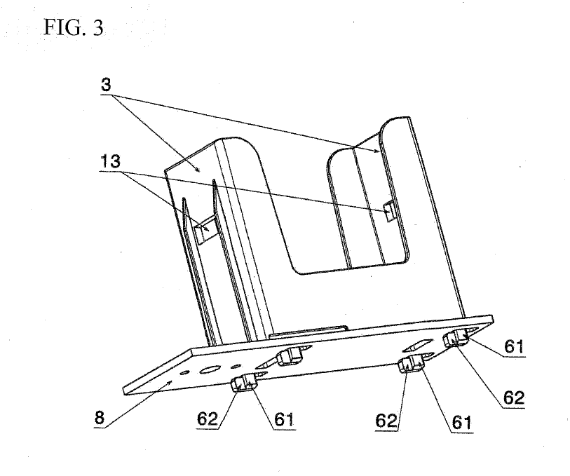

FIG. 3 shows an illustration similar to that according to FIG. 2, but with locking between adapter and wiring carrier by corresponding displacement, wherein the hook-shaped mounting extensions engage below the wiring carrier lower side with the goal of fastening the adapter on the wiring carrier; and

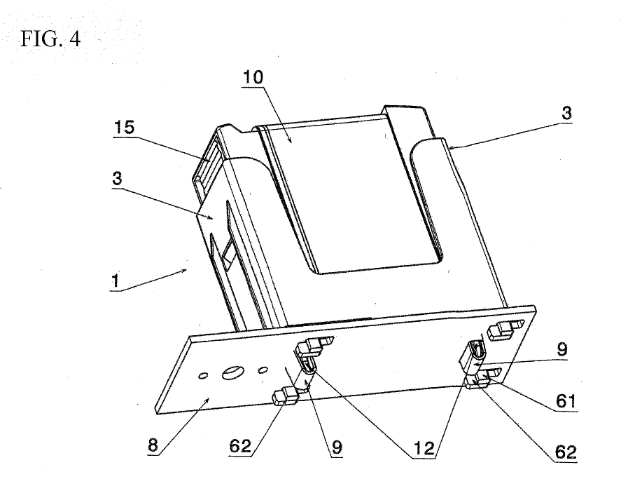

FIG. 4 shows an arrangement similar to that according to FIGS. 2 and 3, but with latched plug-in module, wherein the plug terminals of the plug-in module are seated in a friction-locked manner in through contact recesses of the wiring carrier and the desired surge current resistance arises as a result in conjunction with the locking between the assemblies.

The adapter 1 illustrated in the figures consists of a base 2, which forms a chamber 4, which is open on top and delimited by side walls 3.

Multiple mounting extensions 6 extend from the lower side 5 of the base 2, which mounting extensions have a contour which is essentially complementary to corresponding openings 7 in the wiring carrier 8.

The mounting extensions 6 have a hook shape, as is apparent from FIGS. 2 to 4. In this regard, an angle 62 adjoins a formation 61 oriented in the longitudinal direction of the adapter 1.

The angle 62 has dimensions such that by displacing the adapter in the arrow direction (see FIG. 2), the corresponding mounting extension 6 with adapter is fixed in relation to the wiring carrier 8.

The part 62 of the mounting extension 6 thus engages below the lower side of the wiring carrier 8 to cause the desired locking.

Perforations (not shown in the figures) are located in the base 2, i.e., in the bottom of the base 2. These are formed so that the dimensions thereof enable plug terminals 9 of the plug-in module 10 to be guided through.

Metallized recesses 11 corresponding to the dimensions of the plug terminals 9 of the plug-in module 10 are formed in the wiring carrier 8 such that the recesses 11, after insertion of the adapter 1 and the displacement thereof (see arrow direction according to FIG. 2), are located congruently in relation to the passages in the base, so that after insertion of the plug-in module 10, self-secured locking of the composite made of adapter 1, plug-in module 10, and wiring carrier 8 is provided, in addition to electrical contacting.

As is apparent from FIG. 4, the plug terminals 9 of the plug-in module 10 are formed as U-shaped, wherein a support element 12 is located between the U legs.

The cross section of the plug terminals 9 preferably has a rectangular shape, wherein the recesses 11 in the wiring carrier 8 also have a complementary rectangular design.

The recesses 11 in the wiring carrier 8 are formed as electrical through contacts and are connected to corresponding conductor tracks (not shown).

Catch means are provided between the side walls 3 of the chamber 4 and the plug-in module 10.

The catch means in the side walls 3 of the chamber 4 comprise openings 13, in which a catch lug 14 of the plug-in module 10 engages.

The respective catch lugs 14 are located at the end of a movable actuating surface 15.

As is apparent from FIG. 4, the side walls 3 of the adapter 1 nearly completely conceal the actuating surface 15 in the plugged state of the plug-in module 10 and after completed locking thereof It is therefore no longer possible without effort and/or without the use of tools to move the actuating surfaces 15 in the direction of the center of the plug-in module 10, so that the catch lugs 14 release the openings 13. In this way, the plug-in module 10 is thus secured in the base 1 and with respect to the wiring carrier.

In the above explanations, it was presumed that a respective opening 13 is provided in the side walls 3, which has an operational connection to a catch lug 14 of the plug-in module 10. Of course, a kinematic reversal of the formation or arrangement of openings/catch lugs is also possible here, without leaving the core of the invention.

The plug terminals 9 can consist of copper material, which is electroplated using nickel. For example, sheet-metal strips in a width of 6 mm and having a thickness of 0.5 mm can be used here. The metallized recess implemented in the wiring carrier 8 is, for example, in each case a contact opening in the dimensions 9.2 mm×2.9 mm corresponding to the above-explained embodiment of the sheet-metal strip plug terminals. The described locking with the aid of the special mounting extensions prevents loosening of the connection in the event of mechanical load, so that overall the required strengths are also provided under surge current conditions.

1. An adapter for mounting single-pin or multipin overvoltage protection devices that are designed as plug-in modules (10) on a wiring carrier (8), wherein the adapter (1) has a base (2) and at least one chamber (4), which is open on top and delimited by side walls (3), from the lower side (5) of which multiple mounting extensions (6) extend, which are essentially complementary to corresponding openings (7) in the wiring carrier (8),
characterized in that the mounting extensions (6) have a hook shape (61; 62), in order, after insertion of the adapter (1) with the mounting extensions (6) into the openings (7), by displacement of the adapter in the plane of the wiring carrier (8), to engage below it, wherein perforations are formed in the base (2), the dimensions of which enable plug terminals (9) of the plug-in module (10) to be led through to the wiring carrier, furthermore metallized recesses (11) are formed in the wiring carrier (8) corresponding to the dimensions of the plug terminals (9) of the plug-in module (10) such that the recesses (11), after insertion of the adapter and the displacement thereof, are located congruently in relation to the perforations in the base (2), so that after insertion of the plug-in module (10), self-securing locking of the composite made of adapter (1), plug-in module (10), and wiring carrier (8) is provided in addition to electrical contacting.

2. The adapter according to claim 1,
characterized in that the plug terminals (9) of the plug-in module (10) are formed U-shaped, wherein a support element (12) is located between the U legs.

3. The adapter according to claim 2,
characterized in that the cross section of the plug terminals (9) has a rectangular shape and the recesses (11) in the wiring carrier (8) have a complementary design.

4. The adapter according to claim 1,
characterized in that the recesses (11) in the wiring carrier (8) are formed as electrical through contacts and are connected to corresponding conductor tracks.

5. The adapter according to claim 1,
characterized in that catch means are provided between the side walls (3) of the chamber (4) and the plug-in module (10).

6. The adapter according to claim 1,
characterized in that at least one wiring carrier fastening borehole is provided on the wiring carrier (8) below the base (2), the access to which through the adapter (1) is concealed after the mounting thereof on the wiring carrier (8).

7. The adapter according to claim 5,
characterized in that the catch means comprise openings (13) provided in the side walls (3) of the chamber (4), in each of which a catch lug (14) of the plug-in module (10) engages, wherein the respective catch lug (14) is located at the end of a movable actuating surface (15) and has an insertion bevel.

8. The adapter according to claim 7,
characterized in that the side walls (3), in the plugged state of the plug-in module (10) and after completed locking thereof, predominantly or completely conceal the actuating surface (15) to preclude non-legitimate manipulations or a removal of the plug-in module (10).

9. A use of an adapter according to claim 1 for the solderless mounting and surge-current-resistant connection of plug-in modules on or to wiring carriers, in particular circuit boards.
